(19) United States
(12) Patent Application Publication
(10) Pub. No.: US 2026/0166813 A1
(43) Pub. Date: Jun. 18, 2026

(54) Dynamic Fluid-Assisted Micro Continuous Fluid Interface Production (DF-uCLIP) for Multi-Material and Gradient Material Printing

(71) Applicants: Xiangfan Chen, Gilbert, AZ (US); Wenbo Wang, Gilbert, AZ (US)

(72) Inventors: Xiangfan Chen, Gilbert, AZ (US); Wenbo Wang, Gilbert, AZ (US)

(21) Appl. No.: 19/409,229

(22) Filed: Dec. 4, 2025

Related U.S. Application Data
(60) Provisional application No. 63/733,722, filed on Dec. 13, 2024.

(51) Int. Cl. B29C 64/336; B29B 7/36; B29C 64/129; B29C 64/314; B29K 105/00; B33Y 10/00; B33Y 30/00; B33Y 40/00

(52) U.S. Cl. CPC B29C 64/336; B29B 7/36; B29C 64/129; B29C 64/314; B33Y 10/00; B33Y 30/00; B33Y 40/00; B29K 2105/0088

(57) ABSTRACT

Disclosed herein are systems and methods for production of multi-material structures using continuous liquid interface 3D printing. The systems and methods disclosed herein may enable rapid and precise fabrication of complex 3D graded and/or gradient structures with controlled material distribution. A resin bath may enable dynamic resin switching without pausing the continuous printing. A material management system may provide material storage, material infusion into the resin bath, and material withdrawal from the resin bath. The systems and methods disclosed herein may be applicable to biomedical devices, soft robotics, and/or structural applications.

### CROSS-REFERENCE TO RELATED APPLICATIONS

This application claims priority to, and the benefit of, U.S. Provisional Patent Application Ser. No. 63/733,722 filed on Dec. 12, 2024 entitled “Dynamic Fluid-Assisted Micro Continuous Fluid Interface Production (DF-μCLIP) for Multi-Material and Gradient Material Printing”. The foregoing application is hereby incorporated by reference in its entirety for all purposes, including but not limited to those portions that specifically appear hereinafter, but except for any subject matter disclaimers or disavowals, and except to the extent that the incorporated material is inconsistent with the express disclosure herein, in which case the language in this disclosure shall control.

### STATEMENT AS TO FEDERALLY SPONSORED RESEARCH

This invention was made with government support under 2229279 awarded by the National Science Foundation (NSF). The government has certain rights in the invention.

### TECHNICAL FIELD

The present disclosure relates to 3D printing technology, in particular to high-resolution, multi-material graded structures.

### BACKGROUND

Functionally graded materials (FGMs) offer the ability to create structures with spatially varying properties, enabling advanced performance in applications such as biomedical devices, soft robotics, and structural components. However, existing multi-material 3D printing systems are often slow and inefficient, making the production of complex graded structures time-consuming and impractical for rapid prototyping. Accordingly, improved 3D printing systems and methods remain desirable.

### SUMMARY

Various embodiments of the present disclosure relate to methods and systems for continuous liquid interface 3D printing. While the ways in which various embodiments of the present disclosure address drawbacks of prior systems and methods are discussed in more detail below, in general, exemplary embodiments of the disclosure provide improved systems and methods that include and/or are configured to continuously form a 3D printed object during material switching to provide desired mechanical properties.

In accordance with various embodiments of the disclosure, a method for 3D printing is provided. The method can include providing a first resin to a continuous liquid interface printing system, stopping provision of the first resin to the continuous liquid interface printing system, and providing a second resin to the continuous liquid interface printing system. The continuous liquid interface printing system may not pause printing between the stopping provision of the first resin and the providing of the second resin.

In various embodiments, the first resin and the second resin can be passed through the continuous liquid interface printing system simultaneously. The method can further include mixing the first resin and the second resin to form a mixed resin and/or varying a ratio of the first resin and the second resin within the mixed resin over time.

In various embodiments, the method can further include contacting the first resin, the second resin, and/or the mixed resin with ultraviolet (UV) light within the continuous liquid interface printing system. The UV light can have a wavelength of about 405 nm. A flowrate of at least one of the first resin, the second resin, and/or the mixed resin through the continuous liquid interface printing system can be between about 0.2 mL/min and about 10 mL/min.

In various embodiments, the method can further include continuously forming a 3D printed object. A composition of the 3D printed object between a first end and a second end of the 3D printed object can form a gradient between the first resin and the second resin.

In accordance with various embodiments of the disclosure, a system for continuous liquid interface 3D printing is provided. The system can include a material management system and a resin bath. The material management system can include two or more resins. The continuous liquid interface 3D printing system can be configured to continuously form a 3D printed object during resin switching by the material management system.

In various embodiments, the system can further include a waste collection system fluidly coupled to the resin bath and/or a resin mixing device. The material management system can be configured to provide the two or more resins to the resin mixing device. The resin mixing device can be configured to mix the two or more resins before the two or more resins are provided to the resin bath. The material management system can be configured to vary a ratio of a first resin and a second resin of the two or more resins provided to the resin mixing device over time. The resin mixing device can include a sonicator.

In various embodiments, the system can further include an ultraviolet (UV) light source configured to provide a UV light to the resin bath. The UV light can have a wavelength of about 405 nm.

In various embodiments, a composition of the 3D printed object between a first end of the 3D printed object and a second end of the 3D printed object can form a gradient between a first resin and a second resin of the two or more resins. The material management system can be configured to provide a flowrate of between about 0.2 mL/min and about 10 mL/min of the two or more resins to the resin bath.

These and other embodiments will become readily apparent to those skilled in the art from the following detailed description of certain embodiments having reference to the attached figures. This section is intended as a simplified introduction to the disclosure, and is not intended to limit the scope of any claim.

### BRIEF DESCRIPTION OF THE DRAWINGS

With reference to the following description and accompanying drawings:

FIG. 1 illustrates a system for DF-μCLIP, in accordance with various exemplary embodiments;

FIG. 2 illustrates an exemplary characterization of dynamic material, in accordance with various exemplary embodiments;

FIG. 3 illustrates an exemplary chart of the mechanical strength of a 3D printed multi-material sample, in accordance with various exemplary embodiments;

FIG. 4 illustrates an exemplary set of printing strategies and results, in accordance with various exemplary embodiments;

FIG. 5 illustrates exemplary 3D-printed graded and gradient structures, in accordance with various exemplary embodiments;

FIG. 6 illustrates exemplary 3D-printed functionally graded structures, in accordance with various exemplary embodiments;

FIG. 7 illustrates exemplary 3D-printed gradient composites, in accordance with various exemplary embodiments; and

FIG. 8 illustrates an exemplary method for 3D printing, in accordance with various exemplary embodiments.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from principles of the present disclosure.

In this disclosure, any two numbers of a variable can constitute a workable range of the variable, and any ranges indicated may include or exclude the endpoints. Additionally, any values of variables indicated (regardless of whether they are indicated with about or not) may refer to precise values or approximate values and include equivalents, and may refer to average, median, representative, majority, etc. in some embodiments. For example, the term about can refer to +/−20, 10, 5, 2, or 1 percent of a value. Further, in this disclosure, the terms including, constituted by and having, or related terms, can refer independently to typically or broadly comprising, comprising, consisting essentially of, or consisting of in some embodiments. In accordance with aspects of the disclosure, any defined meanings of terms do not necessarily exclude ordinary and customary meanings of the terms. Yet further “substantially equal” can refer to within +/−5, 2, 1, 0.5, 0.25, or 0.1 absolute percent.

In this disclosure, continuously can refer to one or more of without interruption as a timeline, without any material intervening step, without changing treatment conditions, immediately thereafter, or as a next step in some embodiments. For example, a resin can be supplied continuously during two or more steps of a method.

Various embodiments described herein may include systems and/or methods. The systems and methods may enable rapid, precise fabrication of complex 3D graded structures with controlled material distribution. The systems and methods may achieve 3D printing speed significantly faster than conventional methods. The systems and methods may be configured to enable dynamic resin switching without pausing continuous 3D printing. The systems and methods may include a material management system for material storage, material infusion, and material withdrawal. The systems and methods described herein may provide for and/or enable rapid production of high-resolution, multi-materials graded structures, for example by modified continuous liquid interface production 3D printing.

For the sake of brevity, conventional techniques and components for 3D printing, continuous fluid interface production (CLIP), and/or the like may not be described in detail herein. Furthermore, the connecting lines shown in various figures contained herein are intended to represent exemplary functional relationships and/or communicative couplings between various elements. It should be noted that many alternative or additional functional relationships or communicative connections may be present in exemplary methods and systems for 3D printing and/or components thereof.

The exemplary embodiments disclosed herein may describe a method for rapid, high-resolution continuous 3D printing of compositional graded and/or gradient structures, which may be applicable to fields such as biomedical devices, soft robotics, wearable electronics, aerospace components, or any other advanced applications requiring customized material distributions.

Accordingly, disclosed herein is novel approach to DF-μCLIP. Traditional methods for multi-material 3D printing struggle with speed, efficiency, and weak material interfaces. In contrast, the disclosed DF-μCLIP approach overcomes these limitations by utilizing CLIP alongside dynamic resin switching. DF-μCLIP enables rapid, high-resolution fabrication of functionally graded structures as fast as single-material printing using CLIP. Systems and methods for DF-μCLIP enhance production efficiency, improve the quality of material interfaces, and enable a continuous supply of compositional gradients for seamless and precise gradient printing, making DF-μCLIP suitable for production of biomedical devices, soft robotics with complex material properties, and structural applications requiring high precision and tunable mechanical characteristics, among other uses.

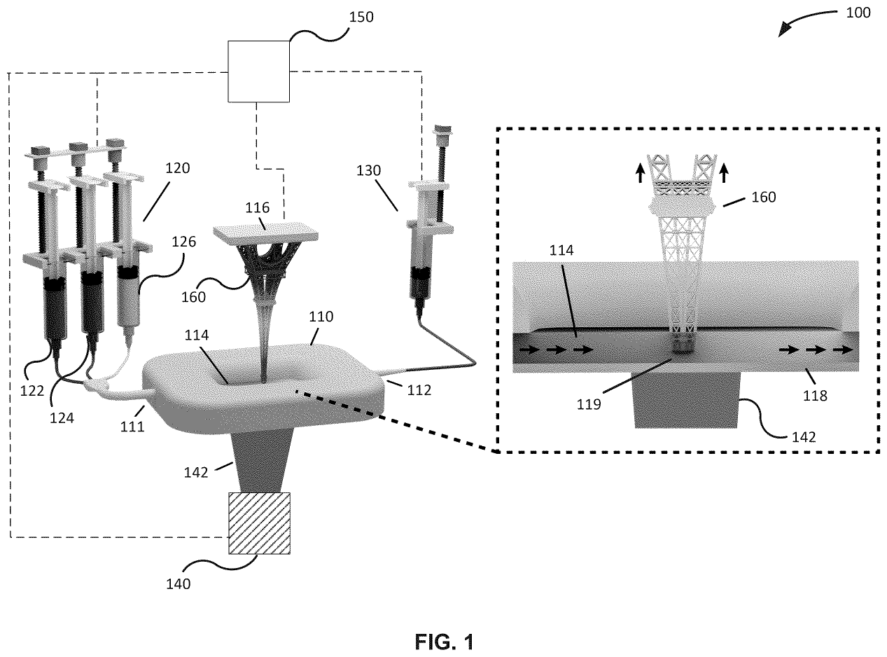

With reference now to FIG. 1, a system 100 for DF-μCLIP is illustrated. The system 100 can include a resin bath 110, a material management system 120, a waste management system 130, an ultraviolet (UV) light source 140, and a controller 150. The system 100 may be configured to form (i.e., 3D print) a 3D printed object 160. In various embodiments, 3D printing of graded materials using system 100 enables the creation of complex structures with varying (e.g., mechanical) properties, design flexibility, improved performance, and optimized material distribution for specific functional requirements in advanced applications.

Resin bath 110 may include an inlet 111, an outlet 112, an aperture 114, a printing platform 116, a membrane 118, and a dead zone 119. The inlet 111 may be fluidly coupled to the material management system 120, described in more detail below. The inlet 111 may be configured to receive one or more resins and/or a mixed resin, for example from the material management system 120, and may be configured to provide the one or more resins and/or a mixed resin to the resin bath 110. A mixed resin may be formed by a mixture of two or more resin materials, for example, two or more of the one or more resins. The one or more resins 122, 124, 126 may be any suitable resin and/or material for use in 3D printing. For example, the inlet 111 may be configured to provide the one or more resins and/or a mixed resin to at least one of the outlet 112, the aperture 114, proximate the printing platform 116, and/or the dead zone 119. The outlet 112 may be configured to receive one or more resins and/or a mixed resin from the resin bath 110, for example from the inlet 111, the aperture 114, and/or the dead zone 119, and may be configured to provide the one or more resins and/or the mixed resin to the waste management system 130, described in more detail below.

The aperture 114 may be disposed on an upper surface of the resin bath 110. The aperture 114 may be configured to expose the one or more resins and/or the mixed resin (i.e., flowing through the resin bath 110) to the printing platform 116. In this manner, the one or more resins and/or the mixed resin may be cured (i.e., by the UV light, described in more detail below) and may form 3D printed object 160 on the printing platform 116. The printing platform 116 may be disposed and/or configured such that it can translate (e.g., descend) towards the aperture 114 of the resin bath and/or translate (e.g., rise) away from the aperture 114 of the resin bath. In this manner, the system 100 may continuously print a 3D printed object 160 on the printing platform 116.

The membrane 118 may be disposed on a bottom surface of the resin bath 110. For example, the membrane 118 may be opposite the aperture 114. The membrane 118 may be disposed such that the one or more resins and/or the mixed resin flow over the membrane 118 (i.e., between the inlet 111 and the outlet 112). The membrane 118 may be any suitable membrane. For example, the membrane 118 may be an O2 permeable membrane.

Material management system 120 may comprise one or more resins materials 122, 124, 126. The one or more resin materials may be configured to be used in 3D printing. The material management system 120 may control the infusion of one or more resins materials, for example resin materials 122, 124, 126, into resin bath 110. A flow rate of the resin materials 122, 124, 126 and/or a mixed resin infused into the resin bath 110 by the material management system 120 may be between about 0.2 mL/min to about 10 mL/min. In this manner, delay height may be reduced from between about 2.3 mm to about 300μm, respectively. Delay height may be defined as the height of a 3D printed object formed that does not include a particular resin material after the particular resin material has begun being infused into the resin bath 110 by the material management system 120. The material management system 120 may infuse the one or more resin materials 122, 124, 126 and/or a mixed resin continuously (i.e., without stopping) during formation of the 3D printed object 160. In this manner, seamless and/or uninterrupted material transitions (i.e., gradients) may be formed within 3D printed object 160. Additionally in this manner, system 100 may significantly increase production speed as compared to standard CLIP systems, for example by eliminating the need for pausing between layers and/or different resin materials. Material management system 120 may be controlled by controller 150, described in more detail below.

Waste management system 130 may receive unused resin material (i.e., resin material that has passed through the resin bath 110 and was not formed into a 3D printed object 160), for example from outlet 112. In this manner, unused resin material may be removed from the resin bath 110 (i.e., a buildup of unused resin material may be prevented).

UV light source 140 may be configured to emit UV light 142. The UV light source 140 may be disposed and/or configured such that the UV light 142 is emitted towards the aperture 114, the printing platform 116, the membrane 118, and/or the dead zone 119. In various embodiments, (e.g., patterned) UV light may cure the resin material flowing through the resin bath 110 (i.e., as the printing platform 116 is continuously translated away from the resin bath). The UV light may be at an exemplary wavelength of about 405 nm, and more generally, from about 360 nm to about 600 nm.

Controller 150 may comprise a non-transitory memory with instructions stored thereon and can be configured to execute one or more processes, the instructions in accordance with any of the exemplary embodiments or methods described herein. Controller 150 may be configured to control the printing platform 116, the material management system 120, the waste management system 130, the UV light source 140, and/or any other desirably controlled component of system 100. For example, controller 150 may be configured to cause the printing platform 116 to translate towards and/or away from the resin bath 110. Controller 150 may be configured to cause the material management system 120 to provide a first resin (i.e., resin 122), to provide a second resin (i.e., resin 124), to stop providing the first resin (i.e., resin 122), and/or to control a flowrate of the one or more resin materials 122, 124, 126 and/or a mixed resin from the material management system 120 to the resin bath 110. The controller 150 may be configured to monitor a level of unused resin in the waste management system 130 and/or to provide an alert (i.e., visual, auditory, or by any suitable means) when the waste management system 130 is full (i.e., cannot accept additional unused resin) or nearly full (i.e., is between about 90 and 99% full, or between about 80 and 99% full, or more than half full). The controller 150 may be configured to enable and/or disable the UV light source 140 (i.e., to enable and/or disable the providing of UV light 142 to the resin bath 110) and/or to control the wavelength of the UV light 142 emitted by UV light source 140.

3D printed object 160 may be any suitable or desired 3D printed object, for example and 3D printed object described herein. For example, 3D printed object 160 can include a graded structure and/or may be and/or be used in functionally graded materials. 3D printed object 160 may have (e.g., spatially) varying properties, for example along a gradient from a first end to a second end. For example, the gradient from the first end to the second end may transition between a first resin and a second resin. Segmented graded 3D printed objects may be formed by system 100 using pause-to-switch methods, wherein 3D printing is paused while infusion of a first resin material is stopped and infusion of a second resin material is started. Intermixed 3D printed objects may be formed by system 100 using on-the-fly switch methods, wherein 3D printing is not paused while infusion of a first resin material is stopped and infusion of a second resin material is started. Gradient 3D printed objects may be formed by system 100 using continuous supply methods, wherein a mixed resin is formed from a first resin and a second resin (i.e., by a mixing device, described in more detail below), and a ratio of the first resin to the second resin within the mixed resin is varied. In this manner, 3D printed objects 160 having spatially tunable mechanical strength, bioreactivity, electrical conductivity, and/or any other desirable characteristic may be formed. 3D printed object 160 may have about 90% or greater printing accuracy for features of 200 μm or larger. 3D printed objects 160 having features of 100 μm or smaller may be formed with desirable printing accuracy by use of lower resin flow rates.

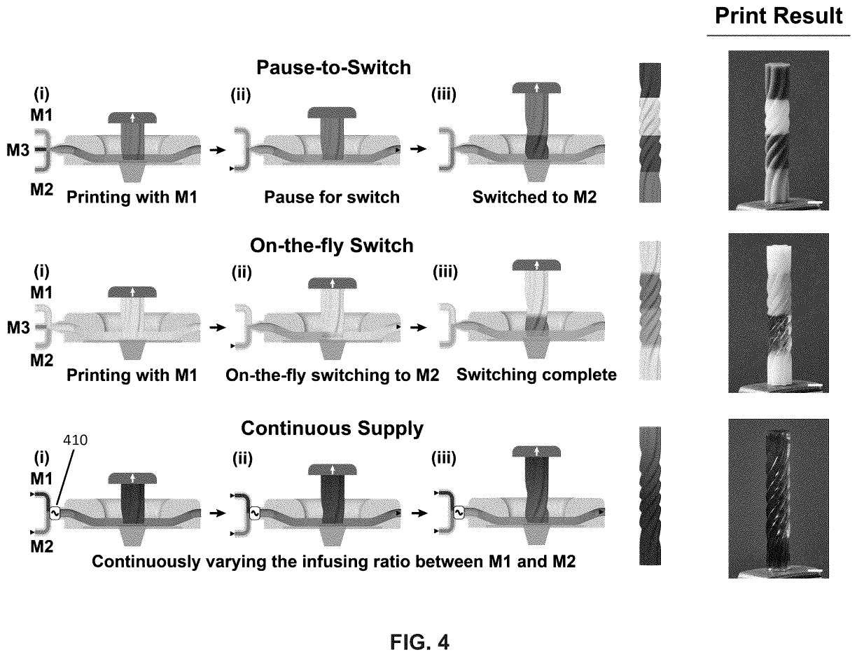

System 100 can further include a mixing device 410 (FIG. 4). Mixing device 410 can be any suitable mixing device. For example, mixing device 410 can be or include a sonicator. Mixing device 410 can be disposed within the resin bath 110 (i.e., within or proximate inlet 111) or within the material management system 120. Mixing device 410 may be configured to mix two or more resins to form a mixed resin.

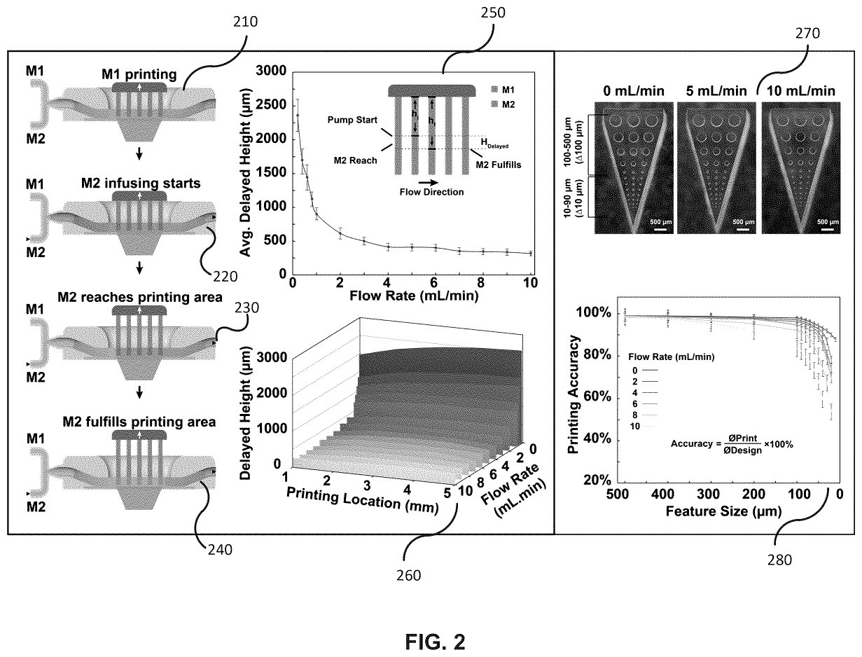

With respect to FIG. 2, an exemplary on-the-fly switching method is illustrated. The method can include providing a first material M1 210, stopping providing M1 and/or providing M2 220, M2 reaching the printing area (i.e., the aperture 114, the printing platform 116, and/or the dead zone 119) 230, and M2 fulfilling the printing area 240. M1 and M2 may be any suitable resin, for example any resin described herein. In this manner, a 3D printed object may have a first portion printed using M1 and a second portion printed using M2. A boundary between M1 and M2 (i.e., within the 3D printed object) may be intermixed. Put another way, a transition between M1 and M2 may not be immediate. The average delayed height plotted against the flow rate of the resin is illustrated by chart 250. The average delayed height plotted against the flow rate and the printing location (i.e., along the 3D printed object) is illustrated by chart 260. Exemplary feature sized at 0 mL/min, 5 mL/min and 10 mL/min flowrates are illustrated by images 270. Exemplary experimental printing accuracy plotted against the feature size at varying flowrates is illustrated by chart 280.

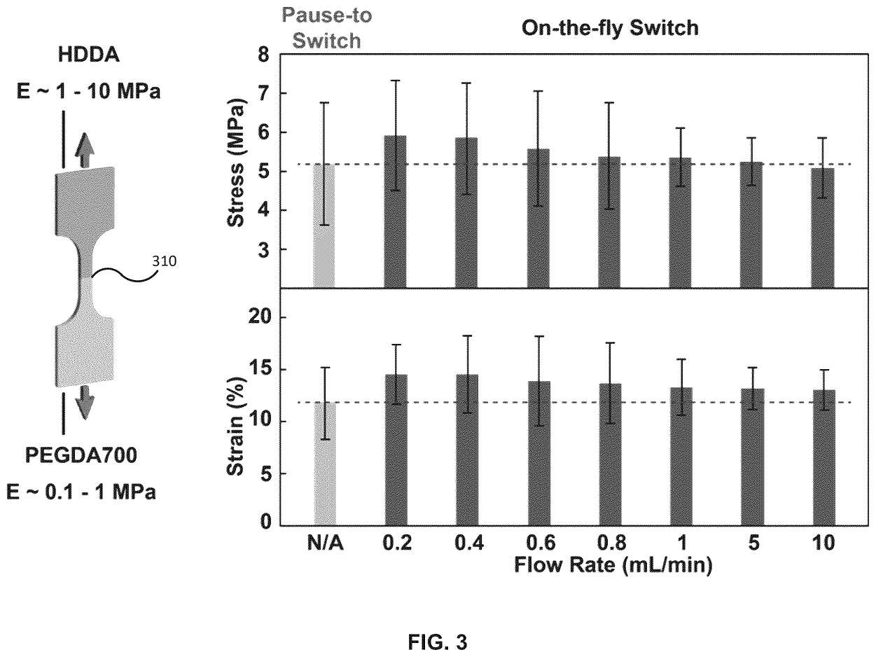

With respect to FIG. 3, tensile tests of multi-material samples are illustrated. The multi-material samples produced using on-the-fly material switching methods, as described herein, exhibited improved mechanical strength at a multi-material interface 310 as compared to conventional pause-to-switch methods. Exemplary systems and methods for DF-μCLIP may be desirable for 3D printing applications in which durability and/or mechanical strength of multi-material interfaces is desirably improved.

With respect to FIG. 4, various 3D printing strategies as disclosed herein are illustrated. Exemplary systems and methods for DF-μCLIP disclosed herein may be used for both the conventional pause-to-switch strategy, the on-the-fly switch strategy, and the continuous supply strategy. The pause-to-switch strategy may be desired in applications where segmented graded structures are desired. The on-the-fly switch strategy may be desired in applications where graded structures with intermixed multi-material interfaces are desired. Exemplary systems and methods support (e.g., true) gradient printing by continuously supplying mixed resin with varying compositions, as described above. The continuous supply strategy may allow for smooth transitions between materials without interrupting the 3D printing process. As such, exemplary systems and methods for DF-μCLIP offer significant flexibility based on the specific 3D printing application desire.

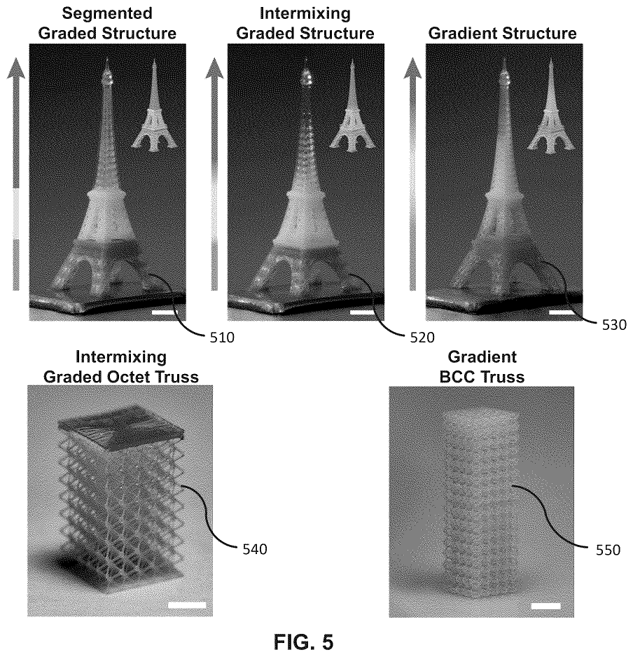

With respect to FIG. 5, exemplary 3D-printed graded and gradient structures are illustrated. The exemplary 3D-printed graded and gradient structures were formed by the exemplary systems and methods for DF-μCLIP described herein. 3D printed object 510 is a segmented graded structure formed by a pause-to-switch method. 3D printed object 520 is a intermixed graded structure formed by an on-the-fly switch method. 3D printed object 530 is a gradient structure formed by a continuous supply method. 3D printed object 540 is an intermixed graded octet truss structure, formed by an on-the-fly switch method. 3D printed object 550 is a gradient BCC truss structure, formed by a continuous supply method. Exemplary 3D printed objects 510, 520, 530, 540, 550 demonstrate the exemplary system and methods capability to produce high-resolution, intricate compositional graded and gradient structures. Exemplary 3D printed objects 510, 520, 530, 540, 550 may be formed by the exemplary systems and methods for DF-μCLIP as fast as or faster than conventional CLIP systems.

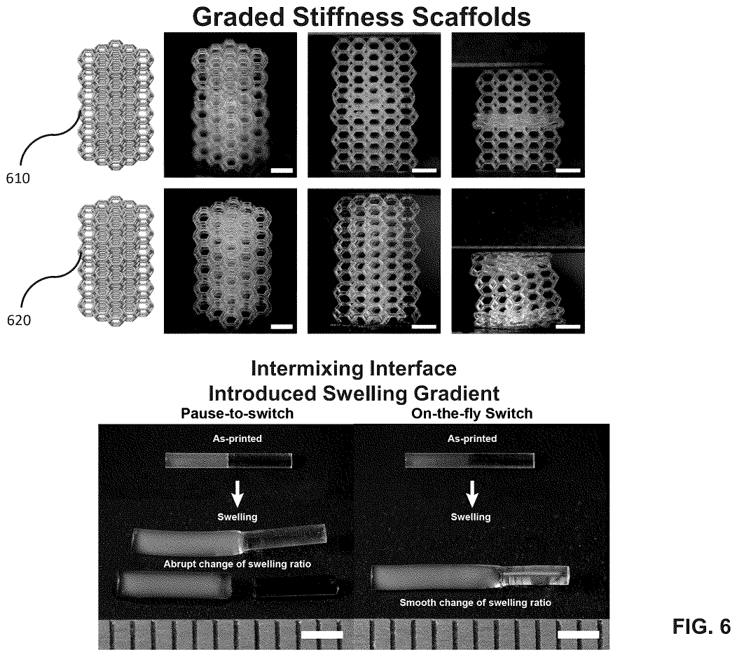

With respect to FIG. 6, exemplary 3D-printed functionally graded structures are illustrated. For example, multi-material graded stiffness scaffolds 610, 620 are illustrated. As illustrated a resin having greater stiffness and/or mechanical strength may be formed in a first region of a 3D printed object as compared to a resin in a second region of a 3D printed object. In this manner, 3D printed objects with desired mechanical failure profiles may be formed. As further illustrated, the pause-to-switch method may cause an abrupt change in a swelling ratio within a 3D printed object, which may provide a weak material interface. The on-the-fly switch method may provide a smooth change in swelling ratio. An intermixed interface formed by on-the-fly switching may cause a swelling gradient within the structure rather than an abrupt change in swelling ratio.

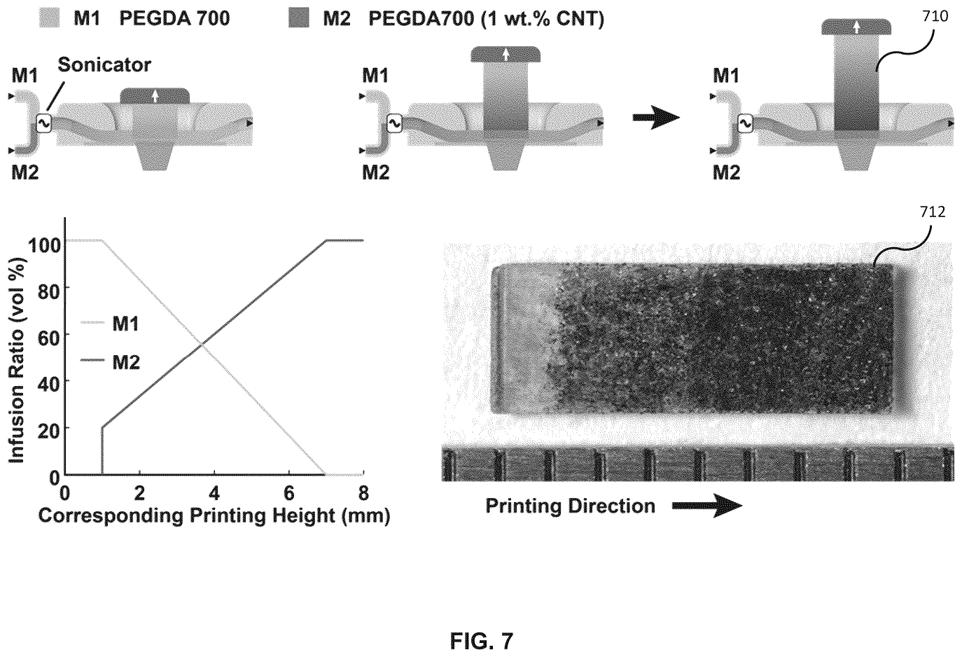

With respect to FIG. 7, exemplary 3D-printed gradient composites are illustrated. The exemplary gradient composites may be formed by a continuous supply method. The illustrated 3D-printed gradient composite 710 may comprise two resin materials M1 and M2; however, a gradient composite produced by the systems and methods described herein may comprise any suitable number of materials. The ratio of M1 to M2 (i.e., vol % ratio) may be varied over time and/or over a print height of a 3D printed object. In exemplary embodiments, a 3D-printed gradient composite 710 may begin printing from one material (i.e., the resin infused to a resin bath may be 100 vol % M1), or may begin printing by a mixed resin. The 3D-printed gradient composite 710 may then be printed from a mixed resin comprising M1 and M2. As illustrated, a vol% of M1 within the mixed resin may be decreased (i.e., at a constant or non-constant rate) and a vol % of M2 within the mixed resin may be increased (i.e., at a constant or non-constant rate). The 3D printed gradient composite 710 may then be printed from one material (i.e., the resin infused to the resin bath may be 100 vol % M2). 3D printed gradient composite 712 illustrates an exemplary 3D printed gradient composited formed according to a continuous supply method as described herein.

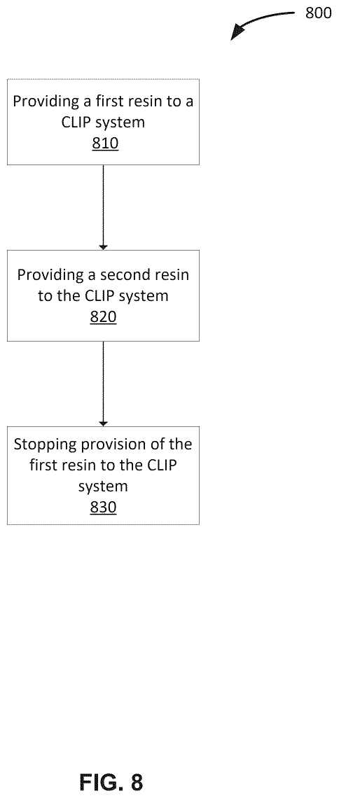

With respect to FIG. 8, a method 800 for 3D printing is illustrated. The method 800 can include providing a first resin to a CLIP system (step 810), providing a second resin to the CLIP system (step 820), and stopping provision of the first resin to the CLIP system (step 830).

Step 810 can include providing a first resin to a CLIP system. The system may be any system disclosed herein, for example, system 100 (FIG. 1). The first resin may be any suitable resin or material, such as any resin described herein. The first resin can be provided to the CLIP system by a material management system as described herein. A flowrate of the first resin through the CLIP system can be between about 0.2 mL/min and 10 mL/min.

Step 820 can include providing a second resin to the CLIP system. The second resin may be any suitable resin or material, such as any resin described herein. The second resin can be provided to the CLIP system by a material management system as described herein. Step 820 may be simultaneous with or may overlap with step 810. A flowrate of the second resin through the CLIP system can be between about 0.2 mL/min and 10 mL/min.

Step 830 can include stopping provision of the first resin to the CLIP system. In various embodiments, step 830 can be simultaneous with step 820. In this manner, the second resin may begin being provided to the CLIP system simultaneously with the stopping of the providing the first resin to the CLIP system. The CLIP system may not pause 3D printing between the stopping provision of the first resin and the providing of the second resin (i.e., the CLIP system may be continuously 3D printing during a switching from the first resin to the second resin). Step 830 can be performed after step 810 and after step 820. In this manner, the first resin and the second resin may be provided to the CLIP system simultaneously. For example, the first resin and the second resin may be mixed to form a mixed resin, as described above.

In exemplary embodiments where step 830 is performed after step 810 and after step 820, method 800 can further include mixing the first resin and the second resin to form a mixed resin. The mixed resin may include a first vol % of the first resin and a second vol % of the second resin. The mixed resin may have a volumetric ratio of the first resin to the second resin. The volumetric ratio may be varies (i.e., over time, over a print height of a 3D printed object, or over any other suitable or desired parameter). A flowrate of the mixed resin through the CLIP system can be between about 0.2 mL/min and 10 mL/min.

In various embodiments, the method 800 may further include contacting the first resin with UV light (e.g., within the CLIP system). In this manner, the first resin may be cured to form a 3D printed object. The method 800 may further include contacting the second resin with UV light (e.g., within the CLIP system). The UV light can have any wavelength described herein, for example, a wavelength of about 405 nm.

It is contemplated that exemplary embodiments enable the production of graded and/or gradient 3D-printed objects with diverse properties. For example, the mechanical strength, bioreactivity, and/or electrical conductivity of a 3D-printed structure or a portion of a 3D-printed structure may be tuned to precise values (e.g., in desired regions of the 3D-printed structure). The versatility and tunability offered by the exemplary embodiments is desirable to, for example, production of advanced materials, soft robotics, biomedical devices, and the like.

As compared to traditional systems and methods for CLIP, exemplary systems and methods for DF-μCLIP disclosed herein offer various advantages, including: 1. Rapid continuous multi-material printing, the exemplary embodiments enable high-resolution, multi-material 3D printing at significantly faster speeds by eliminating the need to pause 3D printing for material switching; 2. On-the-fly material switching, a dynamic resin bath allows seamless transitions between different materials in real time, thereby enhancing production efficiency and interface quality; 3. High-Resolution gradient printing, the exemplary embodiments support the creation of complex graded and gradient structures with precise control over material distribution and transitions, allowing for optimization of properties such as mechanical strength and/or flexibility; 4. Versatile multi-material capability, exemplary embodiments offer flexibility in producing segmented graded structures, intermixed interfaces, or continuous material gradients, meeting a wide range of functional and design desires; 5. Enhanced interface quality, the on-the-fly switching and/or continuous supply promotes better material interface strength and cohesion, improving overall mechanical properties.

The exemplary embodiments disclosed herein provide greatly increased speed and efficiency as compared to conventional multi-material 3D printing methods, which require pauses for material switching. Exemplary embodiments disclosed herein do not require pauses for material switching. Exemplary embodiments disclosed herein enable rapid one-step printing significantly improving production efficiency.

The exemplary embodiments disclosed herein provide multi-material integration, accomplished by on-the-fly material switching and/or continuous supply, enabling for smooth transitions between materials. The distinct and weak material interfaces found in conventional pause-to-switch methods are eliminated by the on-the-fly switching method and/or continuous supply. As a result, exemplary embodiments provide improved structural integrity and mechanical performance of the resulting 3D printed object.

The exemplary embodiments provide high-resolution printing. Conventional technologies face a trade-off between printing resolution and printing efficiency. The disclosure herein minimizes this trade-off by the systems and methods disclosed for DF-μCLIP, enabling precise fabrication of graded and gradient structures at high efficiency.

The exemplary embodiments allow for versatility in material distribution. The exemplary embodiments enable any suitable printing strategy, including segmented printing, intermixed material printing (e.g., on-the-fly switching), and continuous gradient material distribution (e.g., continuous supply). The design flexibility provided by the exemplary embodiments herein allows for complex applications of 3D printing.

The exemplary embodiments may be used in many fields, such as biomedical devices, soft robotics, aerospace applications, and any other fields that rely on or may utilize advanced 3D printing. Through enablement of the rapid production of high-resolution, multi-material structures with enhanced mechanical properties and interface strength, the exemplary embodiments address challenges in customization, performance optimization, and manufacturing efficiency in advanced 3D printing applications.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the specification or claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A method for 3D printing, comprising:
providing a first resin to a continuous liquid interface printing system;
providing a second resin to the continuous liquid interface printing system; and
stopping provision of the first resin to the continuous liquid interface printing system,
wherein the continuous liquid interface printing system does not pause printing between the stopping provision of the first resin and the providing of the second resin.

2. The method of claim 1, wherein the first resin and the second resin are passed through the continuous liquid interface printing system simultaneously.

3. The method of claim 2, further comprising mixing the first resin and the second resin to form a mixed resin.

4. The method of claim 3, further comprising varying a ratio of the first resin and the second resin within the mixed resin over time.

5. The method of claim 1, further comprising contacting the first resin with ultraviolet (UV) light within the continuous liquid interface printing system.

6. The method of claim 5, further comprising contacting the second resin with UV light within the continuous liquid interface printing system.

7. The method of claim 6, wherein the UV light has a wavelength of about 405 nm.

8. The method of claim 6, wherein a flowrate of at least one of the first resin or the second resin through the continuous liquid interface printing system is between about 0.2 mL/min and about 10 mL/min.

9. The method of claim 6, further comprising continuously forming a 3D printed object.

10. The method of claim 9, wherein a composition of the 3D printed object between a first end of the 3D printed object and a second end of the 3D printed object forms a gradient between the first resin and the second resin.

11. A system for continuous liquid interface 3D printing, comprising:
a material management system; and
a resin bath,
wherein the material management system comprises two or more resins, and
wherein the continuous liquid interface 3D printing system is configured to continuously form a 3D printed object during resin switching by the material management system.

12. The system of claim 11, further comprising a waste collection system fluidly coupled to the resin bath.

13. The system of claim 11, further comprising a resin mixing device.

14. The system of claim 13, wherein the material management system is configured to provide the two or more resins to the resin mixing device, wherein the resin mixing device is configured to mix the two or more resins before the two or more resins are provided to the resin bath.

15. The system of claim 14, wherein the material management system is configured to vary a ratio of a first resin of the two or more resins and a second resin of the two or more resins provided to the resin mixing device over time.

16. The system of claim 13, wherein the resin mixing device comprises a sonicator.

17. The system of claim 11, further comprising an ultraviolet (UV) light source configured to provide a UV light to the resin bath.

18. The system of claim 17, wherein the UV light has a wavelength of about 405 nm.

19. The system of claim 11, wherein a composition of the 3D printed object between a first end of the 3D printed object and a second end of the 3D printed object forms a gradient between a first resin of the two or more resins and a second resin of the two or more resins.

20. The system of claim 11, wherein the material management system is configured to provide a flowrate of between about 0.2 mL/min and about 10 mL/min of the two or more resins to the resin bath.
